(19) United States
(12) Patent Application Publication
(10) Pub. No.: US 2008/0089071 A1
(43) Pub. Date: Apr. 17, 2008

(54) Lamp structure with adjustable projection angle

(76) Inventor: Chin-Wen Wang, Pingzhen City (TW)

Correspondence Address: HDSL, 4331 STEVENS BATTLE LANE, FAIRFAX, VA, 22033, US

(21) Appl. No.: 11/548,738

(22) Filed: Oct. 12, 2006

(51) Int. Cl. F21V 29/00

(52) U.S. Cl. 362/294

(57) ABSTRACT

An LED lamp structure with adjustable projection angle includes an aluminum extrusion lamp housing, an LED module, and a rotating rack. The lamp housing has a base, a plurality of heat sinks extended from the base, and a receiving portion formed on an external side of the base. The LED module includes a fixing base, a lampshade on a side of the fixing base, and a plurality of LED lamps in the lampshade, and the fixing base is coupled in the base of the lamp housing. The rotating rack has a hollow cylindrical body, a fixing board extended from a side of the cylindrical body, and a connecting portion formed on the fixing board and connected to the corresponding receiving portion, so that the projection angle of the LED module can be adjusted according to the illumination requirements for different positions and provide the light required for the illumination area.

### BACKGROUND OF THE INVENTION

1. Field of the Invention

The present invention relates to a lamp structure with adjustable projection angle, and more particularly to a lamp structure capable of adjusting a projection angle of an LED module.

2. Description of Prior Art

Since light emitting diodes (LEDs) feature the advantages of high brightness, power saving and long life expectancy, LEDs have been used extensively for illuminations. Several LED lamps are usually arranged and connected to a circuit board to form an LED lamp module and several LED lamp modules are connected in series or in parallel to constitute a lamp structure to achieve an illumination effect that meets the requirements for a large projecting area and a high brightness for outdoor illuminations, and serve for indoor or outdoor illuminations.

A traditional lamp structure includes a lamp housing, a light-transmitting hood, a partition and an LED module, wherein the lamp housing includes a ventilation channel, and the light-transmitting hood is connected to the lamp housing, and the partition is connected horizontally between the lamp housing and the light-transmitting hood for isolating a first space and a second space, and the partition has an opening at its center, and the LED module includes a circuit board, a heat sink mounted separately on both upper and lower flat surfaces of the circuit board and a plurality of LED lamps, and the circuit board is installed at the opening of the partition, and all LED lamps are contained in the second space, and the heat sinks are contained in the first space and composed of a heat pipe and a plurality of heat sinks coupled to the heat pipe, and the heat sinks are stacked with each other, and the foregoing components constitute an LED lamp structure.

However, the traditional LED lamp structure still has the following drawbacks on its usage. Since the traditional lamp structure does not come with a rotating rack connected to the lamp housing, the projection angle of the LED module cannot be adjusted or changed to cope with the illumination requirements for different positions or provide light required in an illumination area, and thus greatly reducing the practicability and the scope of applicability of the lamp structure.

Furthermore, it is necessary to produce different molds for different models of lamp structures according to their specifications or powers, and thus further increasing the cost for making molds and extending the time for developing and manufacturing the lamps. The lamp housing, partition and heat sink must be manufactured separately, not only incurring a cost for making the molds of different components, but also requiring a complicated manufacturing process and increasing the manufacturing and assembling costs significantly. Further, the traditional LED lamp structure only uses heat pipes for heat dissipation, but the heat pipe has a very limited surface area in contact with the LED lamp, and thus the quantity of dissipated heat is also limited. Obviously, the prior art requires further improvements.

### SUMMARY OF THE INVENTION

In view of the foregoing shortcomings of the prior art, the inventor of the present invention based on years of experience in the related industry to conduct experiments and modifications, and finally designed a lamp structure with adjustable projection angle in accordance with the present invention.

Therefore, the present invention is to provide a lamp structure with adjustable projection angle, wherein a rotating rack and a lamp housing are connected to cope with the illumination requirements for different positions, and the projection angle of the lamp can be adjusted and changed to meet the light requirements in the illumination area.

The present invention provides a lamp structure with adjustable projection angle that comprises an aluminum extrusion lamp housing, an LED module and a rotating rack, wherein the lamp housing includes a base, a plurality of heat sinks extended from the base, and a receiving portion formed on an external side of the lamp housing. The LED module includes a fixing base, a lampshade fixed on a side of the fixing base and a plurality of LED lamps contained inside the lampshade, and the fixing base is fixed in the base of the lamp housing. The rotating rack includes a hollow cylindrical body, a fixing board extended from a side of the cylindrical body, and a connecting portion disposed on the fixing board and connected to the corresponding receiving portion of the lamp housing.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an exploded view of a lamp housing, an LED module, and each lampshade in accordance with the present invention;

FIG. 2 is a cross-sectional view of a lamp housing and a rotating rack in accordance wit the present invention;

FIG. 3 is a perspective view of the present invention;

FIG. 4 is a partial perspective view of a lamp structure connected to a lamp rod in accordance wit the present invention;

FIG. 5 is a perspective view of a lamp structure connected to a lamp rod in accordance wit the present invention; and

FIG. 6 is a cross-sectional view of FIG. 5.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

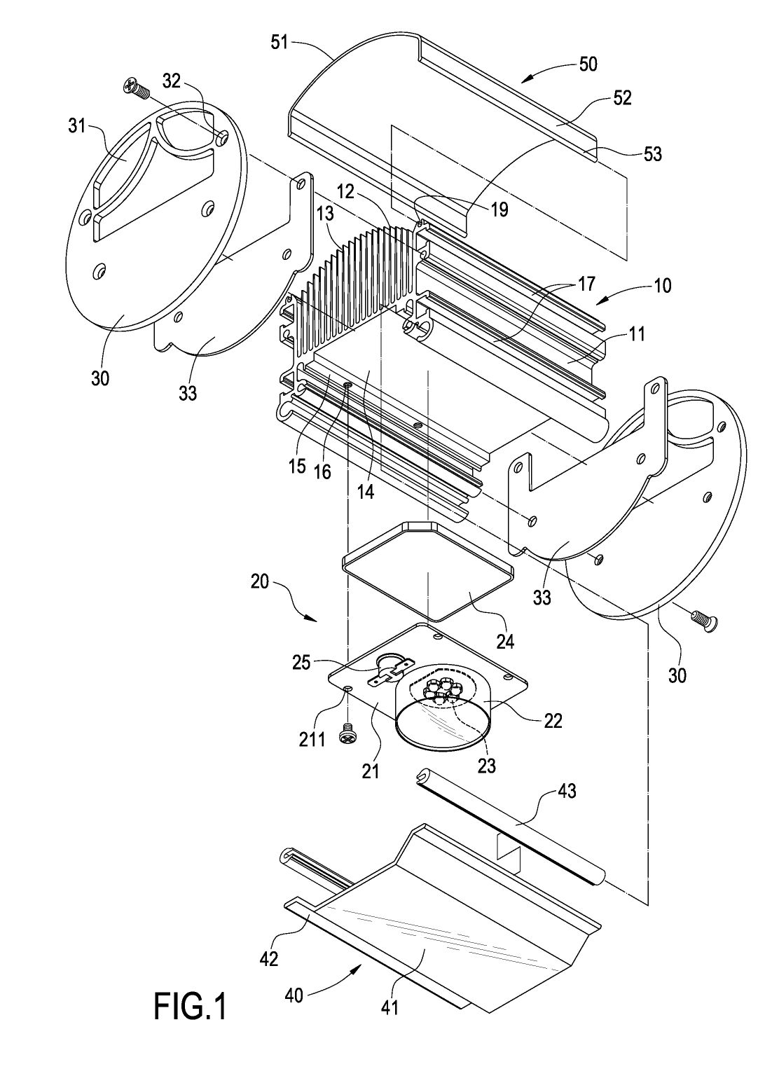

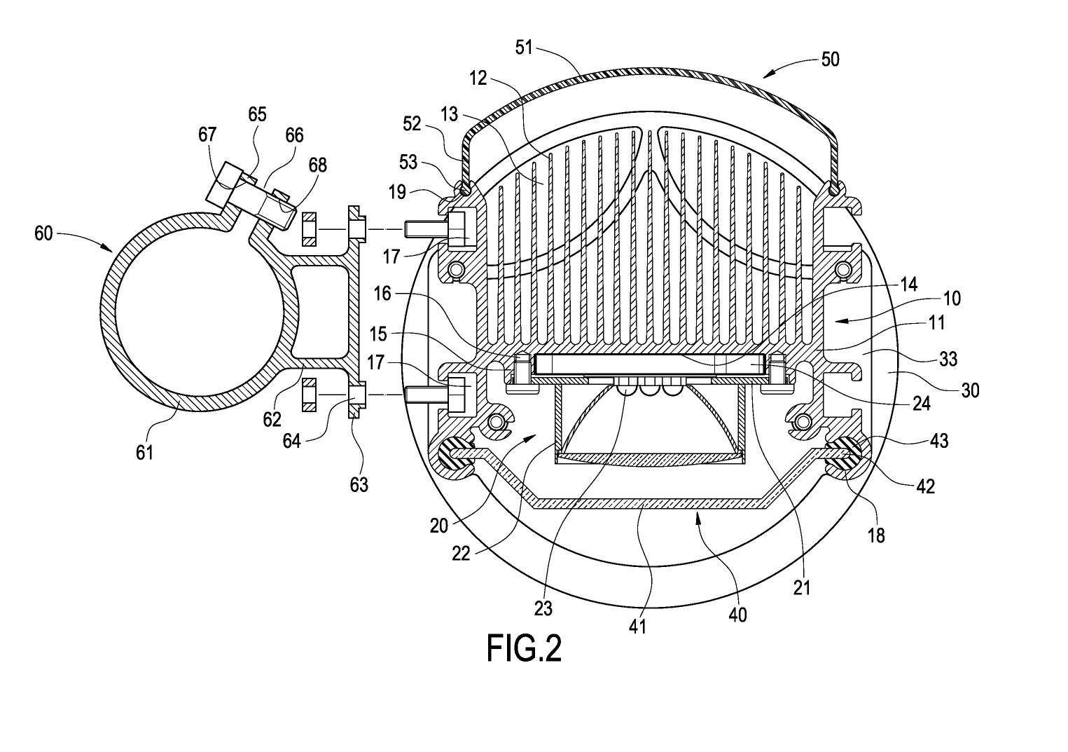

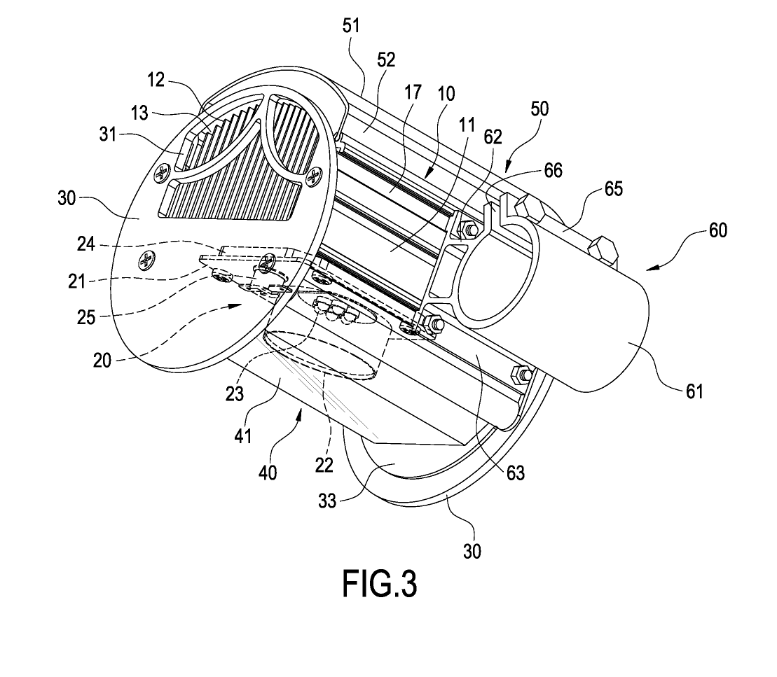

Referring to FIGS. 1 to 3 for an exploded view of a lamp housing, an LED module, and each lampshade in accordance with the present invention, and a cross-sectional view and a perspective view of a lamp housing and a rotating rack in accordance wit the present invention respectively, the invention provides a lamp structure with adjustable projection angle, comprising an aluminum extrusion lamp housing 10, an LED module 20 and a rotating rack 60.

The lamp housing 10 is shaped integrally and extruded by an aluminum material, and the lamp housing 10 includes a substantially H-shape base 11, a plurality of heat sinks 12 extended from a horizontal board of the base 11, and a heat dissipating channel 13 disposed between any two adjacent heat sinks 12. Further, a containing groove 14 is disposed under the horizontal board of the base 11, and parallel protruding bars 15 are formed on both left and right sides of the containing groove 14, and a plurality of screw holes 16 disposed on each protruding bar. Further, a receiving portion 17 is formed on the exterior of a longitudinal board of the base 11, and the receiving portion 17 of this embodiment is a T-shape groove for embedding and fixing the head of a screw bolt, and an embedding groove 18, 19 is formed separately on both sides of the longitudinal board of the base 11.

The LED module 20 includes a fixing base 21 in the shape of a flat board, a lampshade 22 fixed on an external side of the fixing base 21, a plurality of LED lamps 23 installed inside the lampshade 22 and a through hole 211 disposed on the fixing base 21 and corresponding to a screw hole 16 of the base 11 for passing and connecting a screw bolt. In addition, the LED module 20 further includes a heat equalizer 24 and a temperature detector 25, and the heat 25 equalizer 24 is fixed to the fixing base 21 and in the containing groove 14 of the base 11, and both upper and lower flat surfaces of the heat equalizer 24 are attached onto the horizontal board of the base 11 and the back side of each LED lamp 23, and one side of the temperature detector 25 is in contact with the heat equalizer 24 for detecting a change of temperature of the heat equalizer 24 and producing a corresponding connection or disconnection of power, and a thermal grease (not shown in the figure) can be coated on the contact surface between the base 11 and the heat equalizer 24 for improving its thermal conduction efficiency.

The present invention further comprises a plurality of distal covers 30, a plurality of light-transmitting hoods 40 and a plurality of upper casings 50, and the distal cover 30 is a circular board for separately sealing and connecting front and rear sides of the lamp housing 10, and the distal cover 30 includes a ventilation channel 31 and a penetrating hole 32, and the ventilation channel 31 is installed corresponding to the heat sinks 12 of the lamp housing 10 and interconnected with the external airflow, and the penetrating hole 32 is provided for securing fixtures such as a screw bolt. Further, a spacer 33 is included between the distal surfaces of the distal cover 30 and the base 11 for sealing the interior of the base 11. The light-transmitting hood 40 is made of a transparent or semi-transparent material and includes a bent board 41 and two flat boards 42 extended horizontally from the distal ends of the bent board 41. The light-transmitting hood 40 is installed onto the flat board 42 by a waterproof rubber strip 43 and then embedded into an embedding groove 18 of the base 11 for preventing external moisture from entering into the interior. The upper casing 50 also includes a curved board 51 and two sideboards 52 extended downward from the distal ends of the curved board 51, and a circular pillar 53 is formed at the ends of the two sideboards 52 and embedded into the embedding groove 19 of the base 11 for its connection.

The rotating rack 60 includes a hollow cylindrical body 61, a support arm 62 extended from a side of the external periphery of the cylindrical body 61, a fixing board 63 formed at an end of the support arm 62, and a connecting portion 64 disposed on the fixing board 63 and corresponding to the receiving portion 17 of the lamp housing 10, and the connecting portion 64 of this embodiment is a penetrating hole provided for passing and connecting a screw bolt and a screw nut. Further, a pair of clamping arms 65 are formed on a side of the support arm 62 of the cylindrical body 61, and an open groove 66 is formed at each clamping arm 65, and a through hole 67 and a screw hole 68 corresponding to each other are provided for passing and connecting a screw bolt.

In the installation process, the lamp housing 10, LED module 20, distal cover 30, light-transmitting hood 40 and upper casing 50 are installed first, and the head of the screw bolt is embedded into the receiving portion 17 of each base 11, and the screw thread of the screw bolt is exposed to the outside, and the penetrating hole 64 of the rotating rack 60 is sheathed onto each screw thread and secured by a screw nut, so as to complete assembling installing the lamp structure of the present invention.

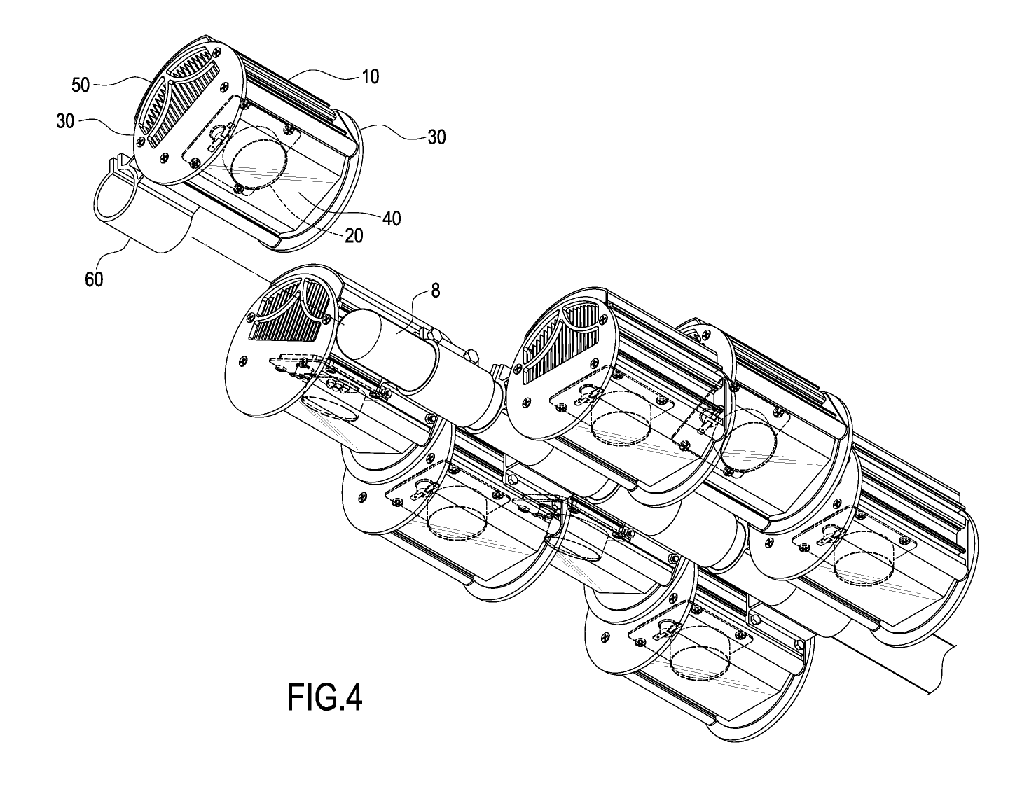

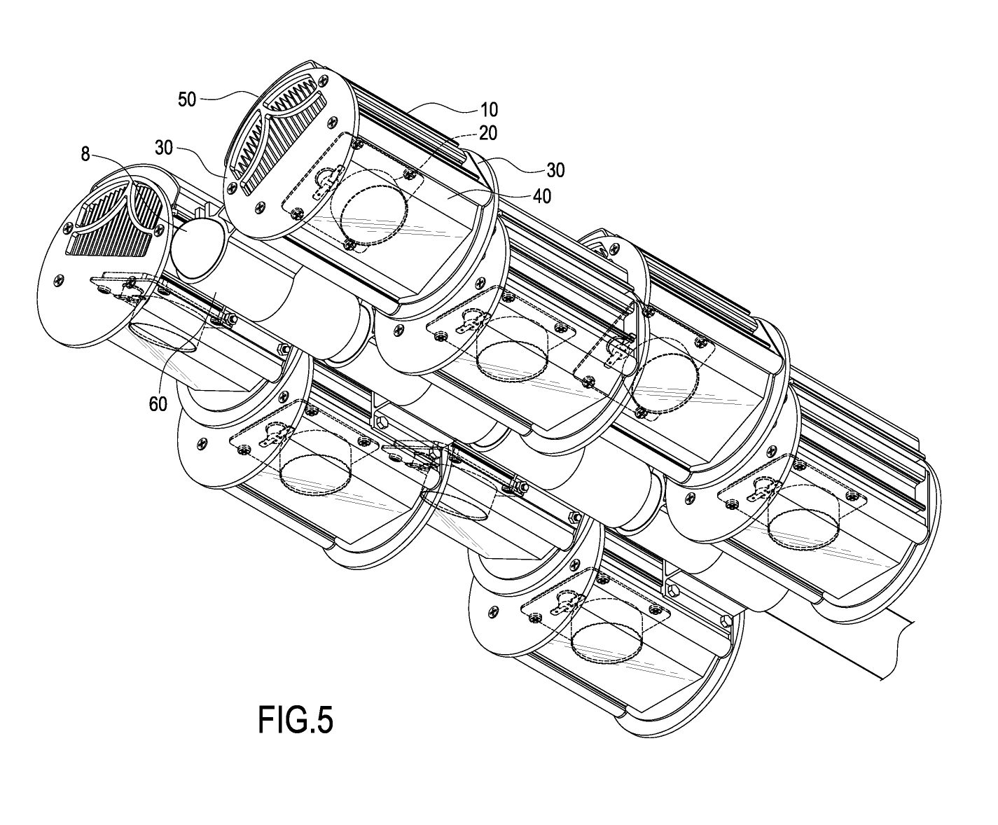

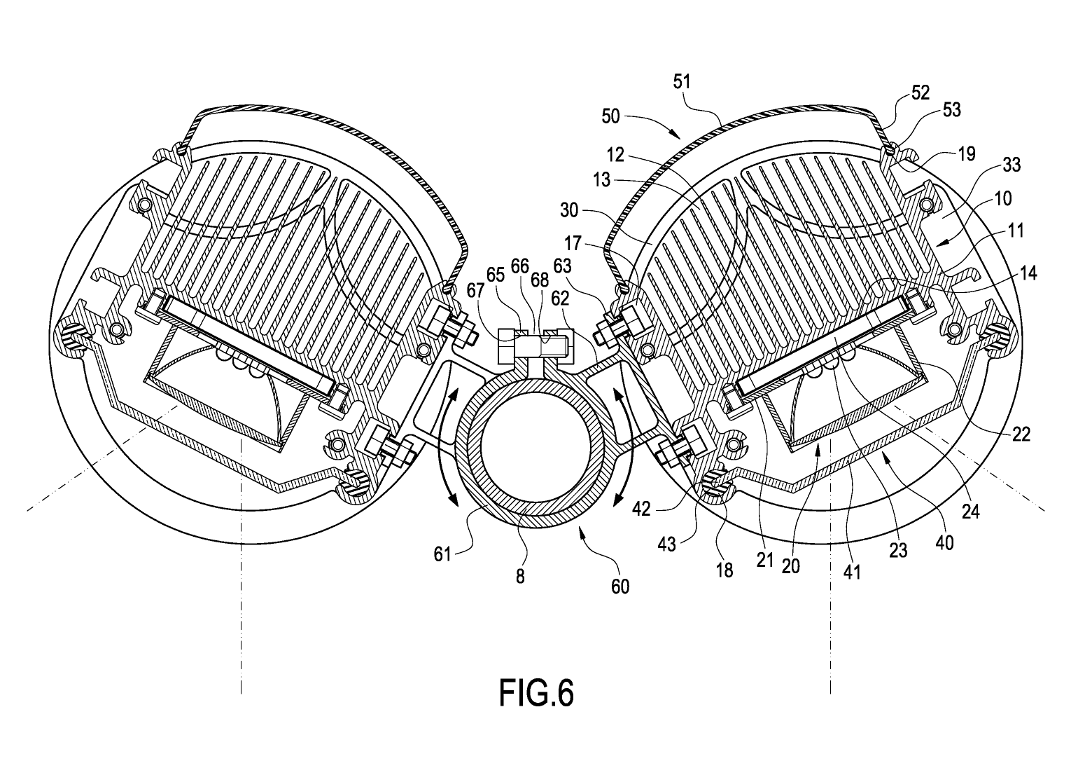

Referring to FIGS. 4 to 6 for a partial exploded view, a perspective view and a cross-sectional view of a lamp structure connected to a lamp rod in accordance with the present invention respectively, a plurality of lamp structures are connected to a lamp rod 8. If it is necessary to change the position of the illumination, the screw bolt secured to the clamping arm 65 of the rotating rack 60 is loosened first, and the projection angle corresponding to each lamp housing 10 and LED module 20 is adjusted and changed individually, and then the screw bolt is secured back on, so as to achieve the light requirements for the illumination area.

When the lamp structure is used, an electric current is passed through each LED lamp 23 and each LED lamp 23 will emit light and produce heat, and the heat will be dissipated quickly to the top surface of the heat equalizer 24 and conducted to the heat sinks 12 of the lamp housing 10 through a large contact area of the heat equalizer 24 and the fluid-phase thermal conduction mechanism, such that each LED lamp 23 can emit light at a lower temperature, and thus extending the life expectancy of the LED lamps.

In summation of the description above, the lamp structure with adjustable projection angle of the invention complies with the patent application requirements and is duly filed for patent application.

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A lamp structure with adjustable projection angle, comprising:
an aluminum extrusion lamp housing, including a base, a plurality of heat sinks extended from the base, and a receiving portion formed on an external side of the lamp housing;
an LED module, including a fixing base, a lampshade fixed on a side of the fixing base, and a plurality of LED lamps contained in the lampshade, and the fixing base being fixed inside the base of the lamp housing; and
a rotating rack, including a hollow cylindrical body, a fixing board extended from a side of the cylindrical body, and a connecting portion disposed on the fixing board and connected to the corresponding receiving portion of the lamp housing.

2. The lamp structure with adjustable projection angle of claim 1, wherein the base is substantially in an H-shape base, and the heat sinks are extended from a horizontal board of the base, and a heat dissipating channel is formed between any two adjacent heat sinks.

3. The lamp structure with adjustable projection angle of claim 2, wherein the base has a containing groove disposed under the horizontal board, and the LED module further includes a heat equalizer fixed in the fixing base and the containing groove and attached respectively to the base and the back side of each LED lamp.

4. The lamp structure with adjustable projection angle of claim 3, wherein the containing groove has a protruding bar formed separately on both sides of the containing groove, and the protruding bar has a plurality of screw holes, and the fixing base has a through hole corresponding to the screw hole for passing and connecting a screw bolt.

5. The lamp structure with adjustable projection angle of claim 3, wherein the LED module further includes a temperature detector attached to the heat equalizer for detecting a change of temperature of the heat equalizer and producing a corresponding connection or disconnection of power.

6. The lamp structure with adjustable projection angle of claim 2, wherein the receiving portion is formed at the exterior of a longitudinal board of the base, and the receiving portion is a T-shape groove, and the connecting portion of the rotating rack is a penetrating hole for embedding and securing a screw bolt and a screw nut.

7. The lamp structure with adjustable projection angle of claim 2, further comprising a plurality of distal covers respectively sealing and connecting both front and rear sides of the base, and the distal cover has a ventilation channel and a penetrating hole, and the ventilation channel is installed corresponding to the heat sinks of the lamp housing, and the penetrating hole is provided for passing and fixing a screw bolt.

8. The lamp structure with adjustable projection angle of claim 7, further comprising a plurality of light-transmitting hoods, each having two flat boards, and an embedding groove formed under the longitudinal board of the base, and the light-transmitting hood 40 being sheathed onto the flat boards by a waterproof rubber strip and installed into the corresponding embedding groove.

9. The lamp structure with adjustable projection angle of claim 8, further comprising a plurality of light-transmitting hoods, each having two sideboards, a circular pillar formed at ends of the two sideboard, and an embedding groove formed on the longitudinal board of the base, and the circular pillar is embedded into and connected to the embedding groove.

10. The lamp structure with adjustable projection angle of claim 1, wherein the cylindrical body includes a support arm extended from a side of the external periphery of the cylindrical body and the fixing board is formed at an end of the support arm.

11. The lamp structure with adjustable projection angle of claim 10, wherein the cylindrical body disposed on a side of the support arm includes a pair of clamping arms disposed thereon, an open groove formed between the clamping arms, and a screw hole corresponding to the through hole for passing and connecting a screw bolt.
